(19) United States
(12) Patent Application Publication
(10) Pub. No.: US 2020/0260017 A1
(43) Pub. Date: Aug. 13, 2020

(54) IMAGE PROCESSING DEVICE, IMAGE COMMUNICATION SYSTEM, AND IMAGE PROCESSING METHOD

(71) Applicant: SHARP KABUSHIKI KAISHA, Osaka (JP)

(72) Inventor: HIROTOSHI OHKUBO, Osaka (JP)

(21) Appl. No.: 16/785,389

(22) Filed: Feb. 7, 2020

(30) Foreign Application Priority Data
Feb. 13, 2019 (JP) 2019-023793

(51) Int. Cl. H04N 5/265; H04N 7/14; H04N 7/15

(52) U.S. Cl. CPC H04N 5/265; H04N 7/15; H04N 7/147

(57) ABSTRACT

An image processing device includes a first storage, a second storage, and a combiner. The first storage stores first image data indicating a first image of a user. The second storage stores real video data indicating a real video of the user. The combiner generates second image data indicating a second image of the user obtained by combining the first image and the real video, based on the first image data and the real video data.

### BACKGROUND OF THE INVENTION

### Field of the Invention

The present invention relates to an image processing device, an image communication system, and an image processing method.

### Description of the Background Art

In recent years, a system for realizing real-time communication at different points via a network is proposed. For example, a communication device for implementing real-time communication by displaying, onto a display device of a communication partner, an image captured by an image capturer is studied (see, for example, Japanese Unexamined Patent Application Publication No. 2008-263500 (hereinafter, Patent Document 1)). In the communication device of Patent Document 1, a more realistic communication is achieved by displaying a user in real size onto a display of the communication partner.

However, in the communication device of Patent Document 1, the display of the communication partner displays the user as the user is in real size. Thus, just as in a case where the user meets directly with the communication partner, the user needs to clothe and make up him/herself, and it is uncomfortable for the user to communicate with the communication partner in a state where the user does not make him/herself presentable.

The present invention has been made in view of the above problem, and an object thereof is to provide an image processing device capable of displaying a partially changed real video of a user, an image communication system therefor, and an image processing method therefor.

### SUMMARY OF THE INVENTION

An image processing device according to the present invention includes a first storage, a second storage, and a combiner. The first storage stores first image data indicating a first image of a user. The second storage stores real video data indicating a real video of the user. The combiner generates, based on the first image data and the real video data, second image data indicating a second image of the user, where the second image is obtained by combining the first image and the real video.

An image communication system according to the present invention includes a first image processing device and a second image processing device connected to the first image processing device via a network. At least one of the first image processing device and the second image processing device includes a first storage, a second storage, and a combiner. The first storage stores first image data indicating a first image of a user. The second storage stores real video data indicating a real video of the user. The combiner generates, based on the first image data and the real video data, second image data indicating a second image of the user, where the second image is obtained by combining the first image and the real video.

An image processing method according to the present invention includes storing first image data indicating a first image of a user, storing real video data indicating a real video of the user, and generating, based on the first image data and the real video data, second image data indicating a second image of the user, where the second image is obtained by combining the first image and the real video.

According to the present invention, it is possible to display a partially changed real video of a user.

### BRIEF DESCRIPTION OF THE DRAWINGS

FIG. 1 is a schematic diagram of an image communication system including an image processing device according to the present embodiment;

FIG. 2 is a schematic diagram of the image communication system including the image processing device according to the present embodiment;

FIG. 3 is a schematic diagram of the image processing device according to the present embodiment;

FIG. 4 is a schematic diagram of the image communication system including the image processing device according to the present embodiment;

FIG. 5 is a schematic diagram of the image processing device according to the present embodiment;

FIG. 6 is a schematic diagram of the image communication system including the image processing device according to the present embodiment;

FIG. 7 is a schematic diagram of the image processing device according to the present embodiment;

FIG. 8 is a schematic diagram of the image communication system including the image processing device according to the present embodiment;

FIG. 9 is a schematic diagram of the image processing device according to the present embodiment;

FIG. 10 is a schematic diagram of the image communication system including the image processing device according to the present embodiment;

FIG. 11 is a schematic diagram of the image processing device according to the present embodiment;

FIG. 12A is a combination availability table in the image processing device according to the present embodiment; and FIG. 12B is a combined-part table in the image processing device according to the present embodiment;

FIG. 13 is a schematic diagram of the image communication system including the image processing device according to the present embodiment;

FIG. 14 is a schematic diagram of the image processing device according to the present embodiment;

FIG. 15 is a schematic diagram of the image communication system including the image processing device according to the present embodiment;

FIG. 16 is a schematic diagram of the image communication system including the image processing device according to the present embodiment;

FIG. 17 is a schematic diagram of the image communication system including the image processing device according to the present embodiment;

FIG. 18 is a schematic diagram of the image processing device according to the present embodiment;

FIG. 19 is an authentication table in the image processing device according to the present embodiment;

FIG. 20A is an authentication table in the image processing device according to the present embodiment, and FIG. 20B is a permitted-device table in the image communication system according to the present embodiment; and

FIG. 21A is a combined-part table in the image processing device according to the present embodiment, and FIG. 21B is a permitted-image table in the image processing device according to the present embodiment.

### DESCRIPTION OF THE PREFERRED EMBODIMENTS

An embodiment of an image processing device and an image communication system according to the present invention will be described below with reference to the drawings. It is noted that, in the drawings, like reference numerals will be used for identical or corresponding parts to omit duplicate descriptions.

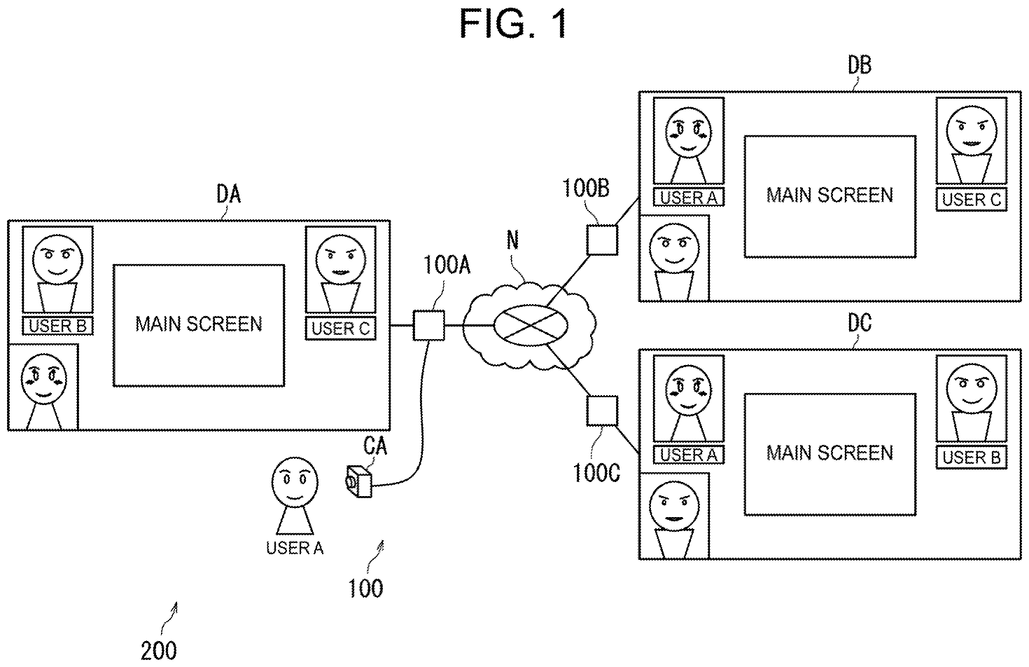

Firstly, an image communication system 200 including an image processing device 100 according to the present embodiment will be described with reference to FIG. 1. FIG. 1 is a schematic diagram of the image communication system 200. The image communication system 200 includes a plurality of image processing devices 100 connected via a network N. The plurality of image processing devices 100 communicate image data with one another in real time via the network N.

Each of the image processing devices 100 includes a processor. In one example, the processor includes a central processing unit (CPU). The processor may include an application specific integrated circuit (ASIC). The image processing device 100 may be implemented as a part of a personal computer (PC) or a smartphone. Alternatively, the image processing device 100 may be a server.

Here, the image communication system 200 includes, as the image processing device 100, three image processing devices 100A, 100B, and 100C. The image processing devices 100A, 100B, and 100C are connected via the network N. Typically, the image processing devices 100A, 100B, and 100C are located apart from one another, and the image processing devices 100A, 100B, and 100C are connected via the Internet or WAN serving as the network N. Alternatively, the image processing devices 100A, 100B, and 100C are located in the same building or the same room, and are connected via LAN serving as the network N. The image processing devices 100A, 100B, and 100C may be similarly configured.

The image processing device 100A is an image processing device corresponding to a user A. The image processing device 100A is located near the user A. A display device DA is connected to the image processing device 100A. The image processing device 100A controls the display device DA. For example, the display device DA includes a liquid crystal display device. Alternatively, the display device DA may include an organic EL display device.

It is noted that the image processing device 100A and the display device DA may be formed as one unit. For example, the image processing device 100A and the display device DA may be implemented as a part of a smartphone. Alternatively, the image processing device 100A and the display device DA may be implemented as a part of a PC.

Similarly, the image processing device 100B is an image processing device corresponding to a user B. The user B is omitted in FIG. 1. The image processing device 100B is located near the user B. A display device DB is connected to the image processing device 100B. The image processing device 100B controls the display device DB.

Further, similarly, the image processing device 100C is an image processing device corresponding to a user C. The user C is omitted in FIG. 1. The image processing device 100C is located near the user C. A display device DC is connected to the image processing device 100C. The image processing device 100C controls the display device DC.

The image communication system 200 is used for a meeting or a game in which the users A, B, and C participate. The display device DA displays a main screen at the center of the display screen and displays the user A at a lower left of the display screen. Further, the display device DA displays the user B at an upper left of the display screen, and displays the user C at an upper right of the display screen.

Similarly, the display device DB displays a main screen at the center of the display screen and displays the user B at a lower left of the display screen. Further, the display device DB displays the user A at an upper left of the display screen, and displays the user C at an upper right of the display screen.

Further, similarly, the display device DC displays a main screen at the center of the display screen and displays the user C at a lower left of the display screen. Further, the display device DC displays the user A at an upper left of the display screen, and displays the user B at an upper right of the display screen. It is noted that a mere example is display positions of the users A to C on the display devices DA to DC in FIG. 1, but display positions are not limited to those in FIG. 1.

It is noted that an image/video capturing device CA is connected to the image processing device 100A. The image/video capturing device CA captures the user A to generate real video data. The image/video capturing device CA includes a camera. The image/video capturing device CA may be a digital camera or a video camera. The real video data includes image data. The real video data may include not only the image data but also voice data. The image processing device 100A and the image/video capturing device CA may be formed as one unit. For example, the image processing device 100A and the image/video capturing device CA may be implemented as a part of a smartphone.

The display device DA connected to the image processing device 100A displays the real video of the user A, based on the real video data of the user A. Further, the image processing device 100A transmits the real video data of the user A generated by the image/video capturing device CA to the image processing device 100B and the image processing device 100C. Each of the image processing device 100B and the image processing device 100C displays the real video of the user A, based on the real video data of the user A.

In the image communication system 200 illustrated in FIG. 1, the user A in front of the image/video capturing device CA applies no eyelashes, blusher, and lipstick, whereas the user A displayed on the display devices DA, DB, and DC applies eyelashes, blusher, and lipstick. In the image communication system 200 according to the present embodiment, it is possible to display the partially changed real video of the user A. Such an image communication system 200 is suitably used for a meeting or a game in which a remote user participates. In particular, the user can participate in a gathering of users without dressing or making up him/herself. For example, the image communication system 200 is suitably used for telework.

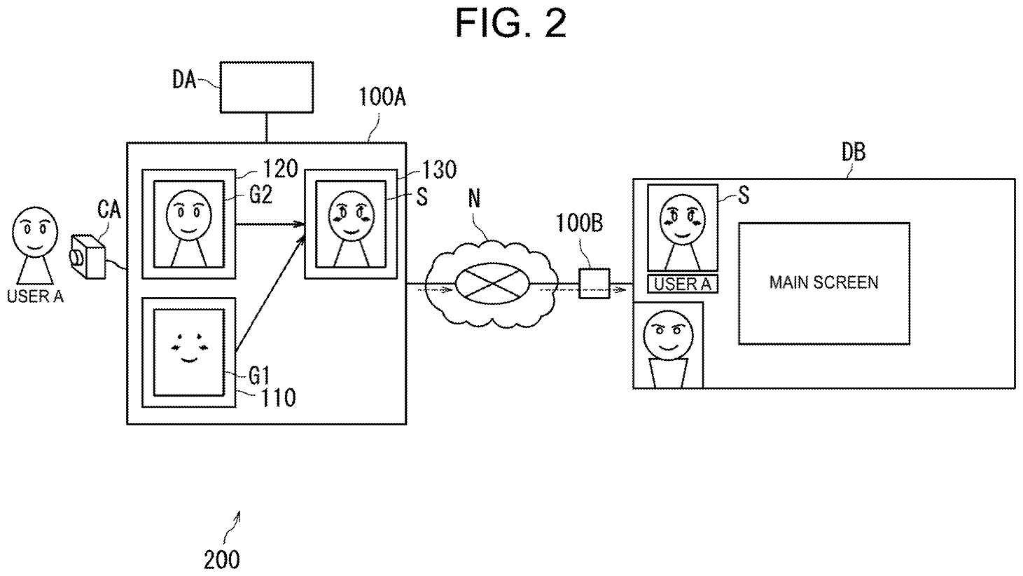

Next, the image communication system 200 including the image processing device 100A and the image processing device 100B will be described with reference to FIG. 2. FIG. 2 is a schematic diagram of the image communication system 200 including the image processing device 100A and the image processing device 100B. It is noted that the image processing device 100C operates in much the same manner as the image processing device 100B, and thus, the image processing device 100C is omitted in FIG. 2.

The image processing device 100A includes a first storage 110, a second storage 120, and a combiner 130. The image/video capturing device CA is connected to the image processing device 100A. The image/video capturing device CA captures a real video of the user A. If the image/video capturing device CA is capable of recording a sound, the image/video capturing device CA captures the real video of the user A and records the sound of the user A.

The first storage 110 stores first image data indicating a first image G1 of the user A. The first image is an image related to the user A. The first image G1 may be an image obtained by capturing the user A is in the past. Alternatively, the first image G1 may be an illustration depicting the user A or an avatar representing the user A.

The first image G1 may be an image representing a portion of the user A or a portion of a background of the user A. For example, the first image G1 includes an image of any of a hair, eyebrows, a forehead, eyes, eyelashes, a nose, a mouth, cheeks, a chin, a contour, clothes, a hat, and glasses of the user A. Further, the first image G1 may include an image of the background of the user A. Alternatively, the first image G1 is an image of two or more parts of the hair, the eyebrows, the forehead, the eyes, the eyelashes, the nose, the mouth, the cheeks, the chin, the contour, the clothes, the hat, the glasses, and the background of the user A.

The first image data may be data of an image captured by the image/video capturing device CA. However, typically, the first image data is data of an image captured in the past by the image/video capturing device CA. Alternatively, the first image data may be data of an image captured by an image/video capturing device other than the image/video capturing device CA.

The second storage 120 stores real video data indicating a real video G2 of the user A. The image/video capturing device CA captures a real video of the user A to generate real video data. The real video data may indicate not only the real video of the user A but also a sound. The image processing device 100A receives the real video data from the image/video capturing device CA, and the second storage 120 stores the real video data of the user A.

The combiner 130 generates second image data indicating a second image S of the user A obtained by combining the first image G1 and the real video G2, based on the first image data of the user A and the real video data of the user A. For example, the combiner 130 generates the second image data from the first image data and the real video data of the user A to indicate the second image S obtained by replacing the eyes (eyelashes), the cheeks, and the mouth in the real video G2 with the first image G1 depicting the eyes (eyelashes), the cheeks, and the mouth.

When the combiner 130 generates the second image data, the first image G1 of the user A with which the real video G2 is replaced may be determined in advance by the user A. Alternatively, the combiner 130 may compare the first image data with the real video data to determine a part to be replaced. For example, the combiner 130 may compare the first image data with the real video data to replace only a part of the real video G2 significantly different from the first image G1, with the first image G1.

It is noted that the combiner 130 may directly utilize the first image data stored in the first storage 110 to generate the second image data in which the first image G1 and the real video G2 are combined. Alternatively, the combiner 130 may process the first image data stored in the first storage 110 so that the first image G1 matches the real video G2 of the user A, and then, utilize the processed data to generate the second image data. For example, even if the first image G1 is a still image and the real video G2 is a moving image, the combiner 130 may process the first image data G1 being a still image to generate image data indicating a moving image corresponding to the first image G1, and then, generate second image data so that the moving image and the real video G2 are combined. If the real video G2 of the user A is a moving image, the combiner 130 preferably replaces a portion of the real video G2 with the first image G1 to generate the second image data so that the first image G1 moves in synchronization with the real video G2.

Further, if selecting or processing the first image with which the real video G2 of the user A is replaced, the combiner 130 may select or process the first image to correspond to a face expression of the real video of the user A. For example, if the user A in front of the image/video capturing device CA smiles, the combiner 130 may select the first image G1 in which the user A smiles and replace a portion of the real video G2 of the user A with a part of the first image G1.

Alternatively, the combiner 130 may select or process the first image G1 to correspond to a user's face expression determined in advance by the user. For example, even if the user A in front of the image/video capturing device CA is crying or angry, the combiner 130 may select the first image G1 in which the user A smiles and replace a part of the real video G2 of the user A with a part of the first image G1 in which the user A smiles. In this case, it is preferable that the combiner 130 analyzes an emotion of the user A by using face authentication.

Here, the combiner 130 generates the second image data of the user A, based on the first image data of the user A and the real video data of the user A. Thereafter, the image processing device 100A transmits the second image data of the user A to the image processing device 100B via the network N.

The image processing device 100B receives the second image data of the user A, and stores the second image data of the user A. Thereafter, the image processing device 100B displays the second image S of the user A indicated in the second image data, onto the display device DB. It is noted that if the combiner 130 does not replace the real video G2 of the user A with any part of the first image G1, the display device DB displays a capturing result of the user A captured by the image/video capturing device CA, without being changed.

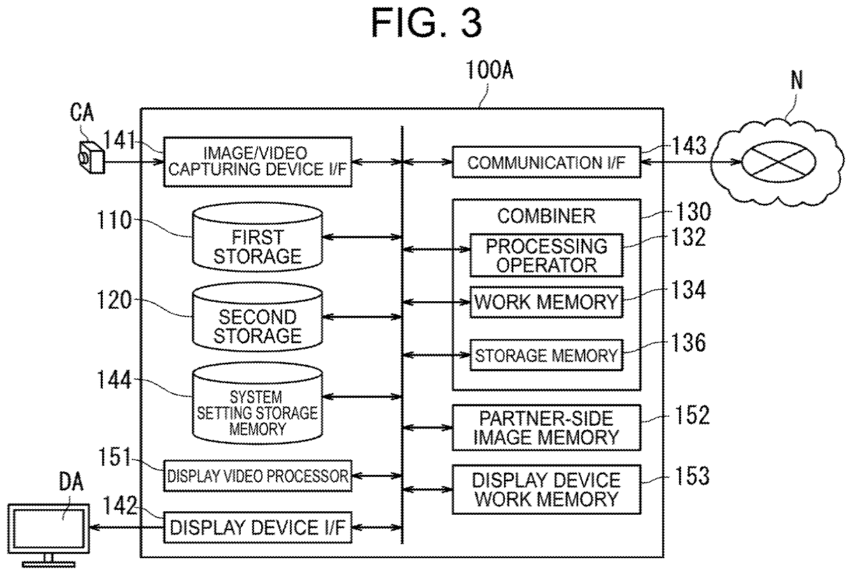

The image processing device 100A according to the present embodiment will be described below with reference to FIG. 1 to FIG. 3. FIG. 3 is a schematic diagram of the image processing device 100A according to the present embodiment.

In addition to the first storage 110, the second storage 120, and the combiner 130, the image processing device 100A includes an image/video capturing device interface 141, a display device interface 142, a communication interface 143, a system setting storage memory 144, a display video processor 151, a partner-side image memory 152, and a display device work memory 153. As described above, the first storage 110 stores the first image data of the user A, and the second storage 120 stores the real video data of the user A.

The combiner 130 includes a processing operator 132, a work memory 134, and a storage memory 136. When the combiner 130 combines the first image and the real video of the user A, the work memory 134 stores the first image data and the real video data of the user A. The processing operator 132 processes the first image data and the real video data so that the first image and the real video of the user A are combined to generate the second image data. The second image data is stored in the storage memory 136. The second image data stored in the storage memory 136 is transmitted to the image processing device 100B via the network N.

The image/video capturing device interface 141 is connected to the image/video capturing device CA and receives the real video data from the image/video capturing device CA. The display device interface 142 is connected to the display device DA and transmits and receives data to and from the display device DA.

The communication interface 143 transmits and receives data to and from the image processing device 100B and/or the image processing device 100C via the network N. The communication interface 143 has a transmitting function of transmitting data to the image processing device 100B and the image processing device 100C. Further, the communication interface 143 has a receiving function of receiving data from the image processing device 100B and the image processing device 100C. The communication interface 143 is an example of a “communicator”.

The system setting storage memory 144 stores information necessary for setting the image communication system 200. It is noted that typically, the first storage 110, the second storage 120, and the system setting storage memory 144 preferably include a non-volatile memory.

The display video processor 151 processes image data for an image displayed on the display device DA. The partner-side image memory 152 stores received image data when the image data is received from outside. The display device work memory 153 stores data to be transmitted to the display device DA. For example, the display device work memory 153 stores the image data of the user A stored in the storage memory 136, and also stores the image data of the user B and the image data of the user C stored in the partner-side image memory 152. The display video processor 151 processes the image data of the users A, B, and C by using the display device work memory 153. The processed image is displayed on the display device DA. Therefore, the display device DA displays the image of the user A, the image of the user B, and the image of the user C.

In the above description with reference to FIG. 1 to FIG. 3, the second image data is generated so that the first image and the real video of the user are combined, and then, the second image data is transmitted via the network N, but the present embodiment is not limited to this. Based on the first image data and real video data of the user received via the network N, the second image data obtained by combining the first image and the real video of the user may be generated.

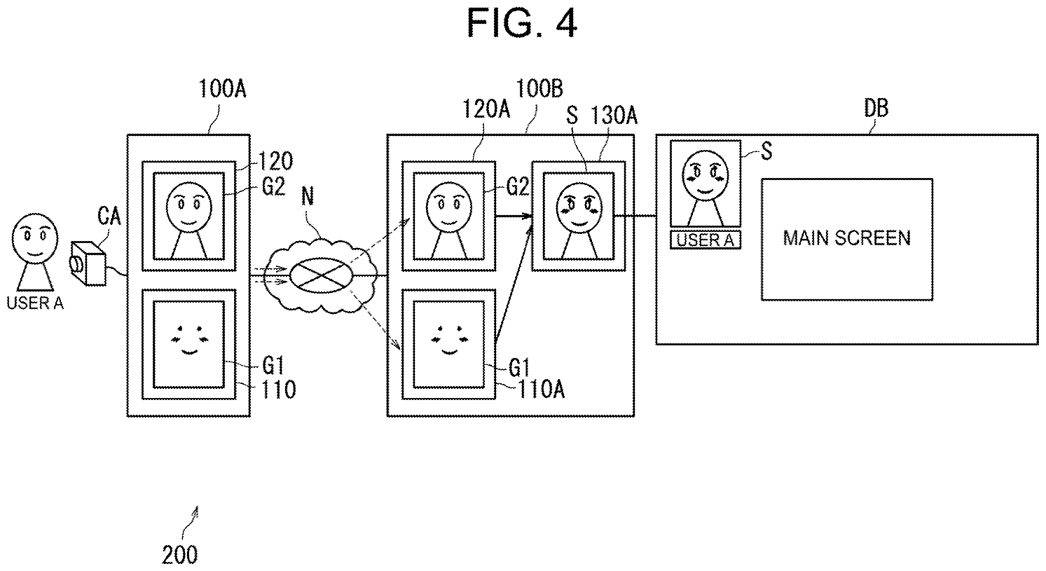

The image communication system 200 including the image processing device 100A and the image processing device 100B according to the present embodiment will be described below with reference to FIG. 4.

FIG. 4 is a schematic diagram of the image communication system 200 including the image processing device 100A and the image processing device 100B. The image communication system 200 in FIG. 4 is configured in much the same way as the image communication system 200 described above with reference to FIG. 2 except that the first image and the real video of the user A are combined in the image processing device 100B, and thus, duplicate description will be omitted for simplicity. As described above, the image processing device 100A and the image processing device 100B may be similarly configured, and here, a configuration for the generation of the second image of the user A will be focused for description, out of configurations of the image processing device 100A and the image processing device 100B. Further, the image processing device 100C operates in much the same manner as the image processing device 100B, and thus, the image processing device 100C is omitted in FIG. 4.

The image processing device 100A includes the first storage 110 and the second storage 120. Further, the image/video capturing device CA is connected to the image processing device 100A. The image/video capturing device CA captures the real video G2 of the user A to generate the real video data indicating the real video G2.

The first storage 110 of the image processing device 100A stores the first image data indicating the first image G1 of the user A. The second storage 120 of the image processing device 100A stores the real video data indicating the real video G2 of the user A. The image processing device 100A transmits the first image data and the real video data of the user A to the image processing device 100B.

The image processing device 100B includes a first storage 110A, a second storage 120A, and a combiner 130A. The first storage 110A stores the first image data of the user A received from the image processing device 100A. The second storage 120A stores the real video data of the user A received from the image processing device 100A.

The combiner 130A generates the second image data indicating the second image S of the user A obtained by combining the first image G1 of the user A and the real video G2 of the user A, based on the first image data of the user A and the real video data of the user A. For example, the combiner 130A generates the second image data so that the eyes (eyelashes), the cheeks, and the mouth of the real video G2 of the user A indicated in the real video data are replaced with the eyes (eyelashes), the cheeks, and the mouth of the first image G1 indicated in the first image data of the user A. After that, the image processing device 100B displays the second image S indicated in the second image data of the user A, onto the display device DB.

In the image communication system 200 according to the present embodiment, the second image S of the user A is generated not by the image processing device 100A but by the image processing device 100B. If a processing capability of the image processing device 100B is higher than that of the image processing device 100A, the second image data of the user A is preferably generated in the combiner 130A of the image processing device 100B. As a result, even if the processing capability of the image processing device 100A is relatively low, it is possible to display a partially changed real video of the user while avoiding a delay.

As described above, the image processing device 100B may receive the real video data of the user A and the first image data of the user A from the image processing device 100A via the network N, and store the first image data of the user A. Alternatively, the image processing device 100B may previously receive the first image data of the user A from the image processing device 100A via the network N and store the first image data of the user A. In one example, the image processing device 100B may previously receive the first image data of the user A from the image processing device 100A, where the first image data may be attached to an email via the network N. Alternatively, the image processing device 100B may previously receive the first image data of the user A from the image processing device 100A via File Transfer Protocol (FTP).

Alternatively, the image processing device 100B may store the first image data of the user A without passing through the network N. For example, the image processing device 100B may store the first image data of the user A via a USB memory.

Alternatively, the image processing device 100B may store address information in which the first image data of the user A is stored. After receiving the real video data of the user A, the image processing device 100B may read the first image data of the user A, based on the address information.

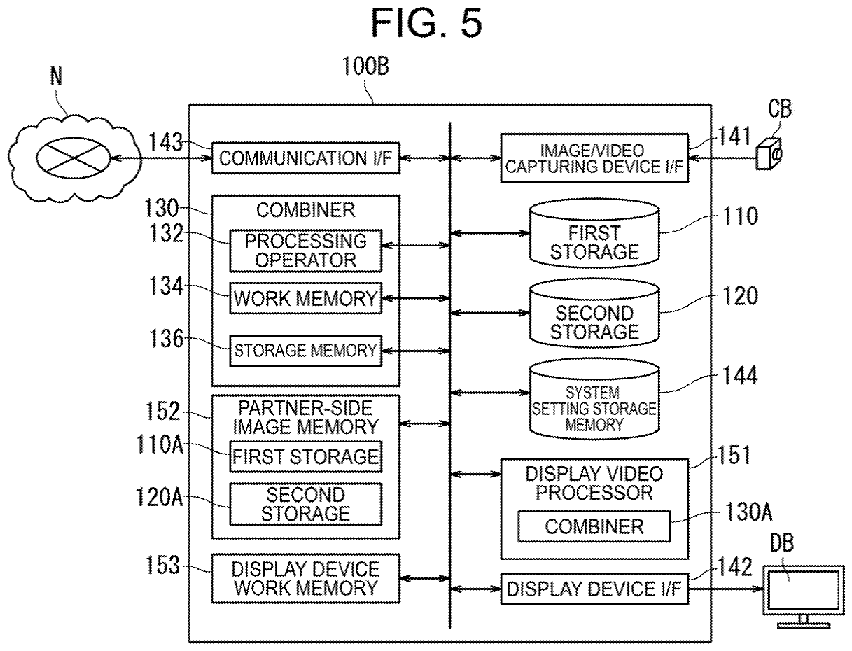

Next, the image processing device 100B according to the present embodiment will be described with reference to FIG. 4 and FIG. 5. FIG. 5 is a schematic diagram of the image processing device 100B according to the present embodiment. The image processing device 100B in FIG. 5 is configured in much the same way as the image processing device 100A described above with reference to FIG. 3 except that the display video processor 151 includes the combiner 130A and the partner-side image memory 152 includes the first storage 110A and the second storage 120A. Thus, duplicated description is omitted for simplicity.

The image processing device 100B includes, in addition to a first storage 110, a second storage 120, and a combiner 130, an image/video capturing device interface 141, a display device interface 142, a communication interface 143, a system setting storage memory 144, a display video processor 151, a partner-side image memory 152, and a display device work memory 153. It is noted that the first storage 110 and the second storage 120 of the image processing device 100B may store the first image data and the real video data of the user B, and the first image data and the real video data of the user B may be transmitted to the image processing device 100A via the communication interface 143.

The partner-side image memory 152 includes a first storage 110A and a second storage 120A. The first storage 110A stores the first image data of the user A received from the image processing device 100A, and the second storage 120A stores the real video data of the user A received from the image processing device 100A.

The display video processor 151 of the image processing device 100B includes the combiner 130A. The combiner 130A generates the second image data of the user A so that the first image G1 and the real video G2 of the user A are combined, based on the first image data of the user A stored in the first storage 110A and the real video data of the user A stored in the second storage 120A. The combiner 130A has a similar function to that of the combiner 130 in FIG. 3. The second image data is stored in the display device work memory 153. The display device DB displays the second image S of the user A, based on the second image data.

In the present embodiment, the combiner 130A of the image processing device 100B generates the second image data of the user A, and the display device DB displays the second image of the user A, based on the second image data. It is noted that the image processing device 100B may transmit the generated second image data to the image processing device 100A. In this case, the display device DA connected to the image processing device 100A displays the second image S of the user A, based on the second image data.

In the above description with reference to FIG. 1 to FIG. 3, the second image data is transmitted via the network N after the second image data indicating the second image is generated by combining the first image and the real video of the user, based on the first image data of the user and the real video data of the user, but the present embodiment is not limited to this. Further, in the above description with reference to FIG. 4 and FIG. 5, the second image data is generated from the first image data and the real video data of the user received via the network N, but the present embodiment is not limited to this. The second image data may be generated from the first image data and the real video data being transmitted via the network N.

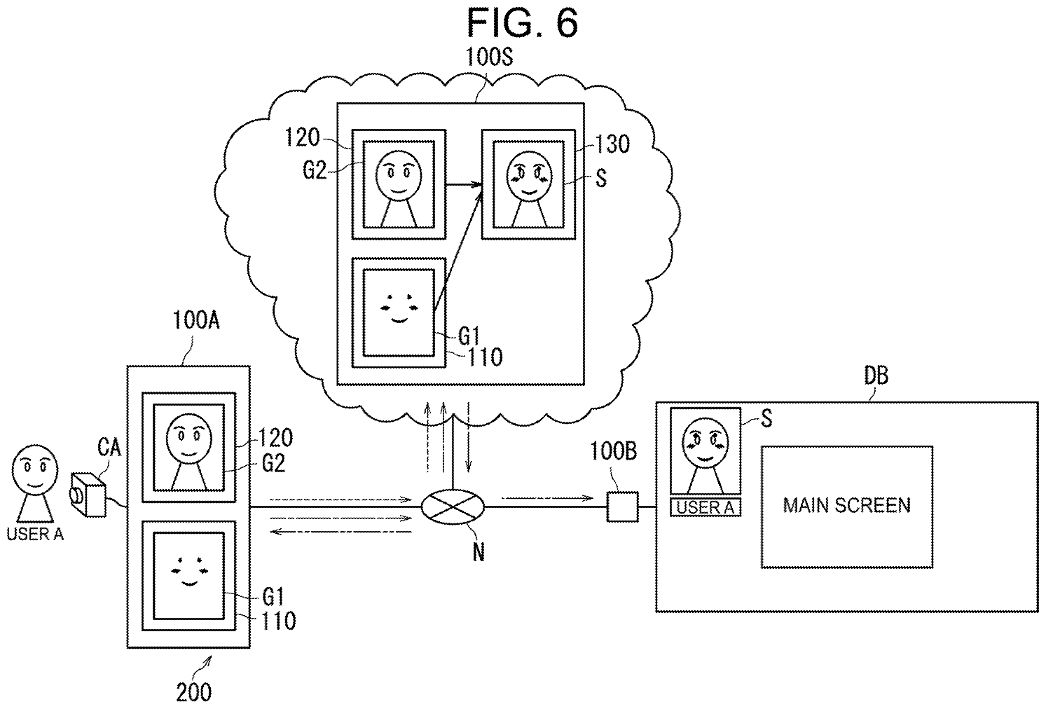

The image communication system 200 including the image processing devices 100A, 100B, and an image processing device 100S according to the present embodiment will be described below with reference to FIG. 6. FIG. 6 is a schematic diagram of the image communication system 200 including the image processing devices 100A, 100B, and 100S according to the present embodiment. The image communication system 200 in FIG. 6 is configured in much the same way as the image communication system 200 described above with reference to FIG. 2 or FIG. 4 except that the first image and the real video of the user A are combined in the image processing device 100S, and thus, duplicate description will be omitted for simplicity. It is noted that the image processing device 100A, the image processing device 100B, and the image processing device 100S may be similarly configured, and here, a configuration for the generation of the second image of the user A will be focused for description, out of configurations of the image processing device 100A, the image processing device 100B, and the image processing device 100S.

The image communication system 200 includes the image processing device 100A, the image processing device 100B, and the image processing device 100S. The image processing device 100S is connected to the image processing device 100A and the image processing device 100B via the network N. The image processing device 100S is a relay device between the image processing device 100A and the image processing device 100B. For example, the image processing device 100S is a server on a cloud.

The image processing device 100A includes the first storage 110 and the second storage 120. Further, the image/video capturing device CA is connected to the image processing device 100A. The image/video capturing device CA captures the real video G2 of the user A to generate the real video data indicating the real video G2.

The first storage 110 of the image processing device 100A stores the first image data indicating the first image G1 of the user A. The second storage 120 of the image processing device 100A stores the real video data indicating the real video G2 of the user A. The image processing device 100A transmits the first image data and the real video data of the user A to the image processing device 100B via the network N.

The image processing device 100S receives the first image data and the real video data of the user A. The image processing device 100S generates the second image data obtained by combining the first image and the real video of the user A, based on the first image data and the real video data of the user A.

The image processing device 100S includes a first storage 110, a second storage 120, and a combiner 130. The first storage 110 of the image processing device 100S stores the first image data indicating the first image G1 of the user A received from the image processing device 100A. The second storage 120 of the image processing device 100S stores the real video data indicating the real video G2 of the user A received from the image processing device 100A.

The combiner 130 of the image processing device 100S generates second image data indicating a second image S of the user A obtained by combining the first image G1 and the real video G2, based on the first image data of the user A and the real video data of the user A. For example, the combiner 130 generates the second image data from the first image data and the real video data of the user A to indicate the second image S obtained by replacing the eyes (eyelashes), the cheeks, and the mouth in the real video G2 with the first image G1 depicting the eyes (eyelashes), the cheeks, and the mouth. Thereafter, the image processing device 100S transmits the second image data to the image processing device 100B.

The image processing device 100B receives the second image data of the user A from the image processing device 100S, and stores the second image data of the user A. Thereafter, the image processing device 100B displays the second image of the user A indicated in the second image data of the user A, onto the display device DB. As described above, it is possible to display an image requested by the user A on the display device DB connected to the image processing device 100B.

In the image communication system 200 according to the present embodiment, the second image of the user A is generated not by the image processing device 100A and the image processing device 100B but by the image processing device 100S. If a processing capability of the image processing device 100S is higher than those of the image processing device 100A and the image processing device 100B, the second image data of the user A is preferably generated in the combiner 130 of the image processing device 100S. As a result, even if the processing capabilities of the image processing device 100A and the image processing device 100B are relatively low, it is possible to display a partially changed real video to provide a desired impression to a communication partner while avoiding a delay.

In the above description with reference to FIG. 4, the image processing device 100A transmits the first image data of the user A to the image processing device 100B via the network N; however, in this way, the image processing device 100S may receive the first image data of the user A together with the real video data of the user A from the image processing device 100A via the network N, and store the first image data of the user A. Alternatively, the image processing device 100S may previously receive the first image data of the user A from the image processing device 100A via the network N and store the first image data of the user A. In one example, the image processing device 100S may previously receive the first image data of the user A from the image processing device 100A, where the first image data may be attached to an email via the network N. Alternatively, the image processing device 100S may previously receive the first image data of the user A from the image processing device 100A via File Transfer Protocol (FTP).

Alternatively, the image processing device 100S may store the first image data of the user A without passing through the network N. For example, the image processing device 100S may store the first image data of the user A via a USB memory.

Alternatively, the image processing device 100S may store address information in which the first image data of the user A is stored. After receiving the real video data of the user A, the image processing device 100S may read the first image data of the user A, based on the address information.

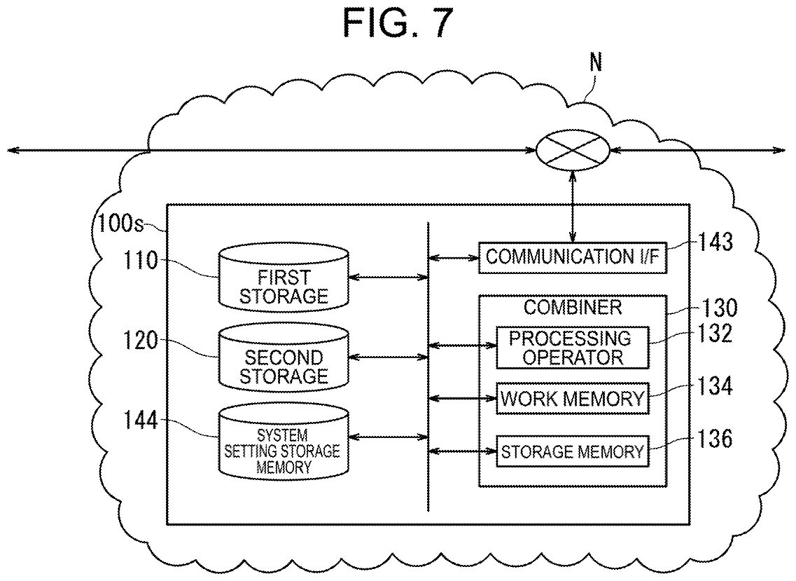

Next, the image processing device 100S according to the present embodiment will be described with reference to FIG. 6 and FIG. 7. FIG. 7 is a schematic diagram of the image processing device 100S according to the present embodiment. The image processing device 100S in FIG. 7 is configured in much the same way as the image processing device 100A described above with reference to FIG. 3 except that the image processing device 100S does not include the image/video capturing device interface 141, the display device interface 142, the display video processor 151, the partner-side image memory 152, and the display device work memory 153. Thus, duplicated description is omitted for simplicity.

The image processing device 100S includes, in addition to the first storage 110, the second storage 120, and the combiner 130, a communication interface 143 and a system setting storage memory 144. Here, the first storage 110 of the image processing device 100S stores the first image data of the user A, and the second storage 120 of the image processing device 100S stores the real video data of the user A.

It is preferable that the first storage 110 of the image processing device 100S stores the first image data of all users who use the image communication system 200. Further, it is preferable that the second storage 120 of the image processing device 100S stores the real video data of all users who use the image communication system 200.

The combiner 130 of the image processing device 100S generates the second image data of the user A so that the first image G1 and the real video G2 of the user A are combined, based on the first image data of the user A stored in the first storage 110 and the real video data of the user A stored in the second storage 120. The combiner 130 includes the processing operator 132, the work memory 134, and the storage memory 136. When the combiner 130 combines the first image G1 and the real video G2 of the user A, the work memory 134 stores the first image data and the real video data of the user A, and the processing operator 132 processes the first image data and the real video data so that the first image G1 and the real video G2 of the user A are combined to generate the second image data of the user A. The second image data is stored in the storage memory 136, and the communication interface 143 transmits the second image data to the image processing device 100B.

In the present embodiment, the combiner 130 of the image processing device 100S generates the second image data of the user A, and transmits the second image data to the image processing device 100B. It is noted that the image processing device 100S may transmit the generated second image data to the image processing device 100A. In this case, the display device DA connected to the image processing device 100A displays the second image of the user A, based on the second image data.

If the real video data includes voice data, it is preferable to combine the voice data with the second image data in consideration of a delay time for combining the first image and the real video.

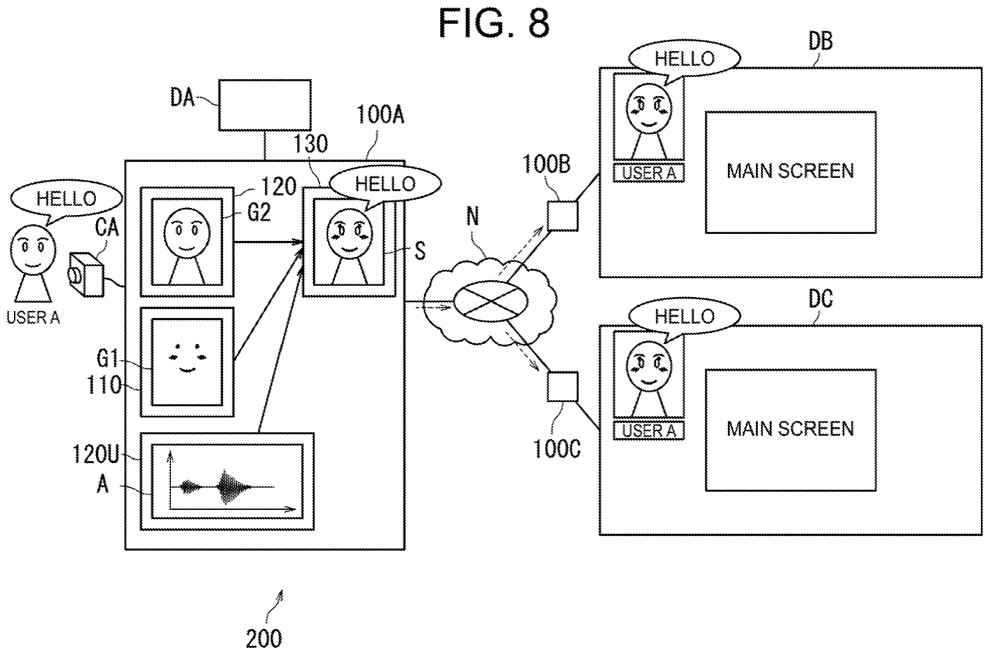

The image communication system 200 including the image processing devices 100A to 100C according to the present embodiment will be described below with reference to FIG. 8. FIG. 8 is a schematic diagram of the image communication system 200 including the image processing devices 100A to 100C according to the present embodiment. The image communication system 200 in FIG. 8 is configured in much the same way as the image communication system 200 described with reference to FIG. 2 except that the image processing device 100A further includes a voice storage 120U in addition to the first storage 110 and the second storage 120, and thus duplicated description is omitted for simplicity. It is noted that as described above, the image processing devices 100A to 100C may be similarly configured, and here, a configuration for the generation of the second image of the user A will be focused for description, out of configurations of the image processing devices 100A to 100C.

The image processing device 100A further includes the voice storage 120U, in addition to the first storage 110, the second storage 120, and the combiner 130. Further, the image/video capturing device CA is connected to the image processing device 100A. The image/video capturing device CA captures a real video of the user A. Here, the image/video capturing device CA also records a voice. For example, a microphone is attached to the image/video capturing device CA. It is noted that the recording may be performed by a member different from the image/video capturing device CA.

The first storage 110 of the image processing device 100A stores the first image data of the user A. The image/video capturing device CA captures a real video of the user A to generate real video data. Here, the real video is a moving image. Further, the image/video capturing device CA records a real voice of the user A and generates real voice data.

The second storage 120 of the image processing device 100A stores the real video data of the user A. Further, the voice storage 120U of the image processing device 100A stores the real voice data of the user A.

The combiner 130 generates the second image data indicating the second image S of the user, where the second image S is obtained by combining the first image G1 and the real video G2 of the user A, based on the first image data of the user A, the real video data of the user A, and the real voice data of the user A and combines the real voice in synchronization with the moving image of the second image S. If a delay occurs when the combiner 130 generates the second image data, the combiner 130 combines, with the delay time, the real voice in synchronization with the second image. When the real voice is combined, the combiner 130 preferably combines the real voice in synchronization with a face expression and/or a movement of lips in the real video of the user A.

For example, the combiner 130 generates the second image data so that the eyes (eyelashes), the cheeks, and the mouth of the real image of the user indicated in the real video data are replaced with the eyes (eyelashes), the cheeks, and the mouth indicated in the first image data. Further, the combiner 130 combines the real voice data in synchronization with the second image data. Thereafter, the image processing device 100A transmits the second image data of the user A to the image processing device 100B and the image processing device 100C via the network N.

The image processing device 100B and the image processing device 100C receive the second image data of the user A and store the second image data of the user A. Thereafter, the image processing device 100B and the image processing device 100C display the second image of the user A indicated in the second image data of the user A, onto the display device DB and the display device DC. At this time, the display device DB and the display device DC display the second image and output the real voice of the user A. In the image communication system 200 according to the present embodiment, the real video data and the voice data are individually stored, and in consideration of the delay time for combining the first image and the real video, the second image data and the voice data are combined, as a result, it is possible to prevent an asynchronization between the second image and the real voice.

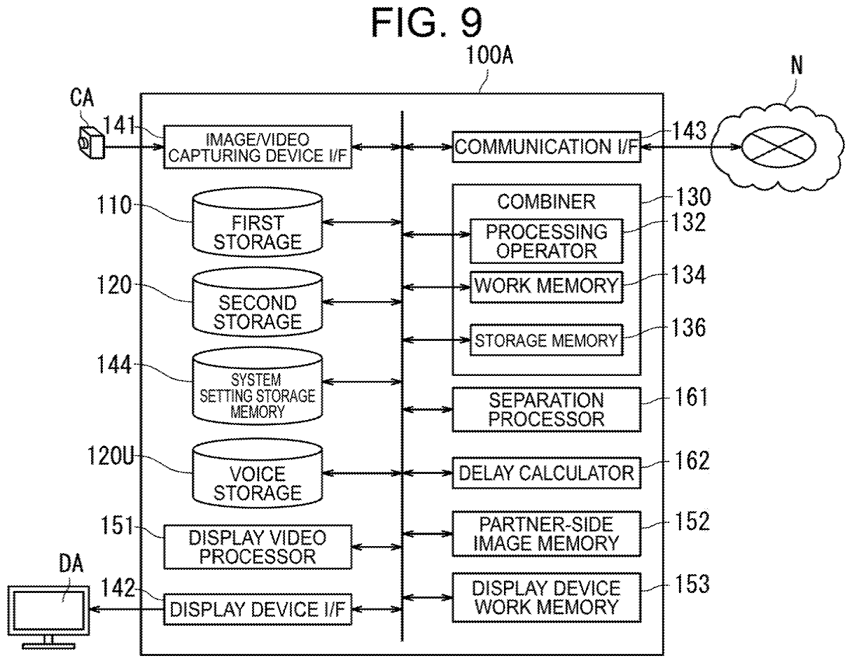

Next, the image processing device 100A according to the present embodiment will be described with reference to FIG. 8 and FIG. 9. FIG. 9 is a schematic diagram of the image processing device 100A according to the present embodiment. The image processing device 100A in FIG. 9 is configured in much the same way as the image processing device 100A described above with reference to FIG. 3 except that the image processing device 100A further includes the voice storage 120U, a separation processor 161, and a delay calculator 162. Thus, duplicated description is omitted for simplicity.

The image processing device 100A further includes the voice storage 120U, the separation processor 161 and the delay calculator 162, in addition to the first storage 110, the second storage 120, the combiner 130, the image/video capturing device interface 141, the display device interface 142, the communication interface 143, the system setting storage memory 144, the display video processor 151, the partner-side image memory 152, and the display device work memory 153. The first storage 110 stores the first image data of the user A, and the second storage 120 stores the real video data of the user A.

The separation processor 161 separates the data generated in the image/video capturing device CA into the real video data and the real voice data. The real video data is stored in the second storage 120. The real voice data is stored in the voice storage 120U.

The delay calculator 162 calculates a delay time occurring when the processing operator 132 of the combiner 130 processes the first image data and the real video data to generate the second image data. Thereafter, the processing operator 132 of the combiner 130 combines the real voice data with the second image data, with the delay time obtained by the delay calculator 162. The second image data combined with the real voice data is stored in the storage memory 136. The second image data stored in the storage memory 136 is transmitted to the image processing device 100B and the image processing device 100C via the network N.

In the above description with reference to FIG. 1 to FIG. 9, if the first image data, the real video data, and/or the second image data are transmitted from one image processing device to a plurality of image processing devices, the same data is transmitted to all the receiving devices, and the plurality of image processing devices display the second image on the display device, based on the same second image data, but the present embodiment is not limited to this. The plurality of image processing devices may display different images on different display devices.

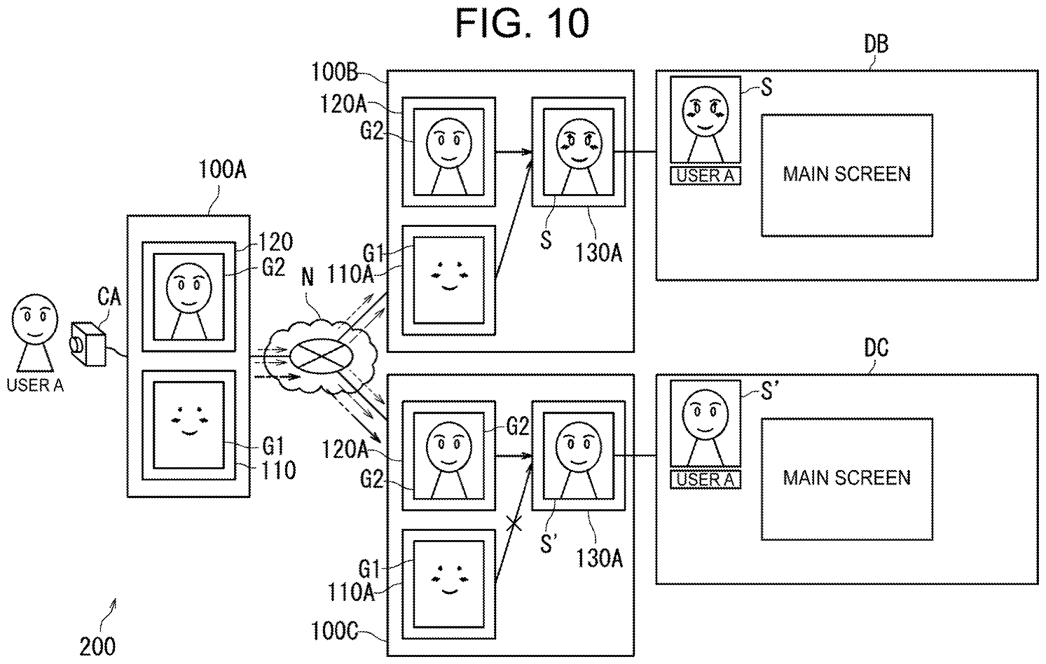

The image communication system 200 including the image processing devices 100A to 100C according to the present embodiment will be described below with reference to FIG. 10. FIG. 10 is a schematic diagram of the image communication system 200 including the image processing devices 100A to 100C according to the present embodiment. The image communication system 200 in FIG. 10 is configured in much the same way as the image communication system 200 described above with reference to FIG. 4 except that the image processing device 100A instructs the image processing device 100B to combine the first image and the real video while instructing the image processing device 100C not to combine the first image and the real video, and thus, duplicated description is omitted for simplicity. It is noted that as described above, the image processing devices 100A to 100C may be similarly configured, and here, a configuration for the generation of the second image of the user A will be focused for description, out of configurations of the image processing devices 100A to 100C.

The image processing device 100A includes the first storage 110 and the second storage 120. Further, the image/video capturing device CA is connected to the image processing device 100A. The image/video capturing device CA captures the real video of the user A to generate the real video data.

The first storage 110 of the image processing device 100A stores the first image data of the user A. The second storage 120 of the image processing device 100A stores the real video data of the user A.

The image processing device 100A transmits the real video data to the image processing device 100B and the image processing device 100C. However, the image processing device 100A transmits a combination selection signal only to the image processing device 100C. Here, the combination selection signal transmitted to the image processing device 100C indicates that combination between any part of the first image and the real video is not permitted. It is noted that the image processing device 100A may selectively transmit the combination selection signal in response to an instruction from the user A.

The image processing device 100B includes the first storage 110A, the second storage 120A, and the combiner 130A. The first storage 110A of the image processing device 100B stores the first image data of the user A. The first image data of the user A may be received prior to the real video data, or may be received together with the real video data. The second storage 120A of the image processing device 100B stores the real video data of the user A received from the image processing device 100A.

The image processing device 100B does not receive the combination selection signal from the image processing device 100A. Thus, the combiner 130A of the image processing device 100B generates the second image data indicating the second image of the user A in which the first image of the user A and the real video of the user are combined, based on the first image data of the user A and the real video data of the user A. For example, the combiner 130A of the image processing device 100B generates the second image data so that the eyes (eyelashes), the cheeks, and the mouth of the real image of the user indicated in the real video data are replaced with the eyes (eyelashes), the cheeks, and the mouth indicated in the first image data. Thereafter, the image processing device 100B displays the second image of the user A indicated in the second image data of the user A, onto the display device DB.

The image processing device 100C includes a first storage 110A, a second storage 120A, and a combiner 130A. The first storage 110A of the image processing device 100C stores the first image data of the user A. The first image data of the user A may be received prior to the real video data, or may be received together with the real video data. The second storage 120A of the image processing device 100C stores the real video data of the user A received from the image processing device 100A.

However, the image processing device 100C receives, from the image processing device 100A, the combination selection signal indicating that the combination between any part of the first image and the real video is not permitted. Therefore, unlike the image processing device 100B, the combiner 130A of the image processing device 100C does not generate the second image data indicating the second image of the user A. Therefore, the image processing device 100C displays a real video S′ of the user A indicated in the real video data of the user A, onto the display device DB.

As described above, in the image communication system 200 according to the present embodiment, it is possible to select a first user in which the partially changed real video of a second user is displayed, from among users using the same image communication system 200. Therefore, it is possible to change the real video of a user as desired according to a communication partner.

In the above description with reference to FIG. 10, when combining one second image, the image processing device 100A transmits the combination selection signal to the image processing device 100C while not transmitting the combination selection signal to the image processing device 100B, but the present embodiment is not limited to this. When combining a plurality of second images, the image processing device 100A may selectively transmit the combination selection signal to the image processing device 100B and the image processing device 100C.

Further, in the above description with reference to FIG. 10, to facilitate understanding of the present embodiment, the image processing device 100A does not transmit the combination selection signal to the image processing device 100B, and transmits, to the image processing device 100C, the combination selection signal indicating that the combination between any part of the first image and the real video is not permitted, but the present embodiment is not limited to this. The image processing device 100A may transmit the combination selection signal indicating that the combination between any selected part of the first image and the real video is permitted, and the combination between any unselected part of the first image and the real video is not permitted.

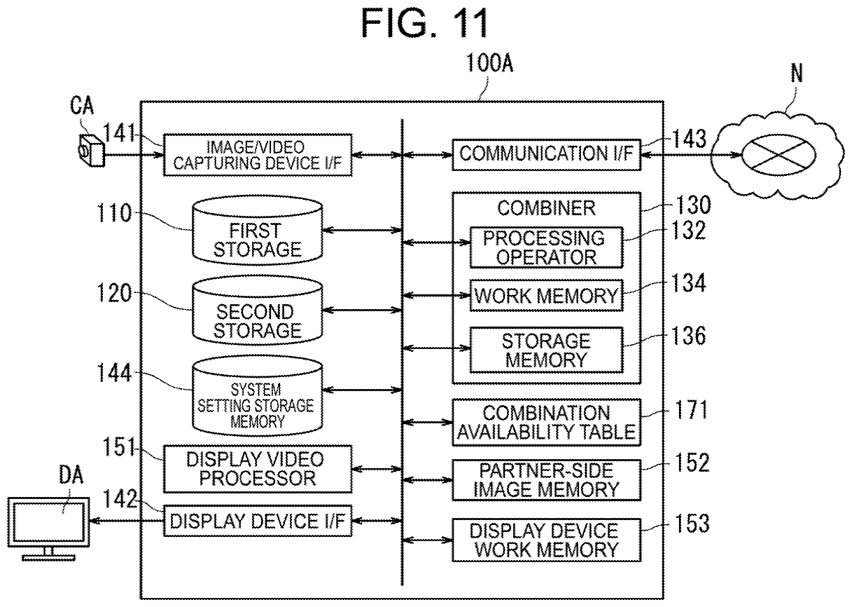

Next, the image processing device 100A according to the present embodiment will be described with reference to FIG. 10 to FIG. 12A. FIG. 11 is a schematic diagram of the image processing device 100A according to the present embodiment. The image processing device 100A in FIG. 11 is configured in much the same way as the image processing device 100A described above with reference to FIG. 3 except that the image processing device 100A further includes a combination availability table 171. Thus, duplicated description is omitted for simplicity.

The image processing device 100A further includes the combination availability table 171 in addition to the first storage 110, the second storage 120, the combiner 130, the image/video capturing device interface 141, the display device interface 142, the communication interface 143, the system setting storage memory 144, the display video processor 151, the partner-side image memory 152, and the display device work memory 153. As described above, the first storage 110 stores the first image data of the user A, and the second storage 120 stores the real video data of the user A.

The combiner 130 includes the processing operator 132, the work memory 134, and the storage memory 136. When the combiner 130 combines the first image and the real video of the user A, the work memory 134 stores the first image data and the real video data of the user A, and the processing operator 132 processes the first image data and the real video data so that the first image and the real video of the user A are combined to generate the second image data by. The second image data is stored in the storage memory 136. The communication interface 143 transmits the second image data stored in the storage memory 136 to the image processing device 100B and the image processing device 100C via the network N. In addition, the communication interface 143 transmits, to each of the users, information indicating a part of the first image of the user A usable for the combination, based on the combination availability table 171.

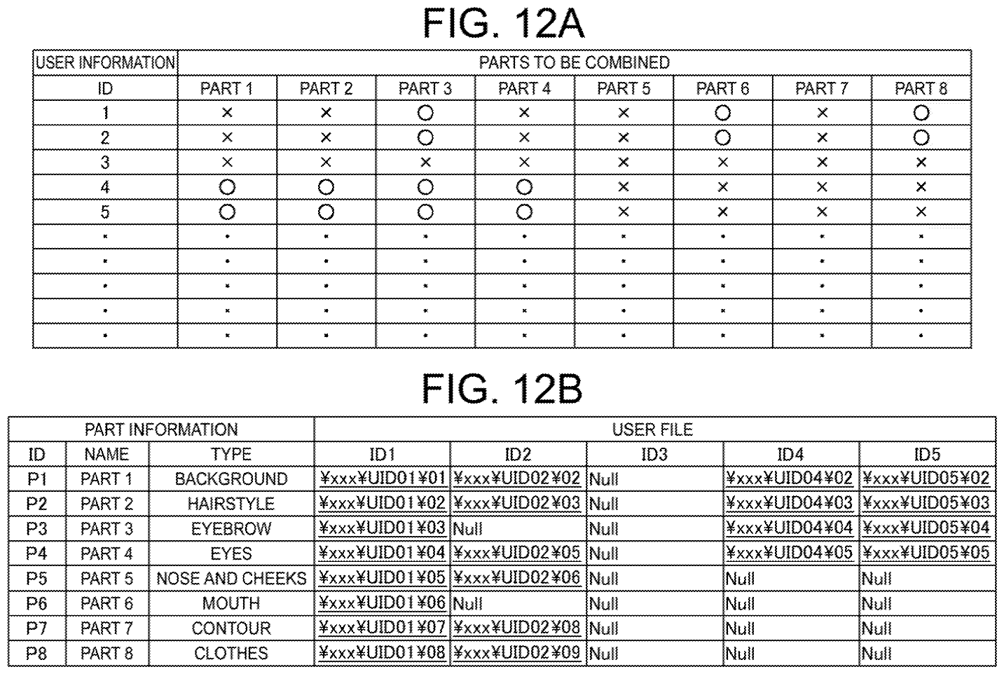

The combination availability table 171 shows a part of the first image for which combination is permitted for each of the users. Here, the combination availability table 171 will be described with reference to FIG. 12. FIG. 12A shows the combination availability table 171 in the image processing device 100A.

The combination availability table 171 shows information indicating whether parts 1 to 8 are combinable for each user information (user ID). For example, ID1 is an IP address of the image processing device 100A of the user A itself, ID2 is an IP address of the image processing device 100B of the user B, and ID3 is an IP address of the image processing device 100C of the user C. For example, as shown in rows of ID2 of the combination availability table 171, the combination selection signal transmitted to the image processing device 100B indicates that the combination of the parts 1, 2, 4, 5, and 7 is prohibited and that of the parts 3, 6, and 8 is permitted.

In the above description with reference to FIG. 10 to FIG. 12A, the image processing device 100B and the image processing device 100C store all the parts of the first image of the user A of which the second image is combined, but the present embodiment is not limited to this. The image processing device may not store all the parts of the first image for the user of which the second image is combined.

Next, the image processing device 100B according to the present embodiment will be described with reference to FIG. 10 to FIG. 12B. FIG. 12B shows a combined-part table in the image processing device 100B. The combined-part table is stored in the storage memory 136 of the image processing device 100B.

Here, ID1 is an IP address of the image processing device 100B of the user B itself, ID2 is an IP address of the image processing device 100A of the user A, and ID3 is an IP address of the image processing device 100C of the user C. For example, as shown in columns of ID1 of the combined-part table, the image processing device 100B stores all the parts of the first image of the user B. Further, as shown in columns of ID2, the image processing device 100B stores a background, a hairstyle, eyes, a nose, cheeks, a contour, and clothes of the first image of the user A, and does not store eyebrows and a mouth of the first image of the user A. Thus, even if the image processing device 100B receives the real video data of the user A from the image processing device 100A, it is not possible to generate the second image data in which the eyebrows and the mouth of the user A are replaced.

Further, as understood from a comparison between FIG. 12A and FIG. 12B, the image processing device 100B may generate the second image data so that the real video of the user A is replaced with the part selected in the first image of the user A, based on the combination between the combination selection signal from the image processing device 100A and the combined-part table.

In the above description with reference to FIG. 9 to FIG. 12A, the user A instructs replacement of the real video of the user A with the part selected in the first image of the user A, but the present embodiment is not limited to this.

In the above description with reference to FIG. 3 and FIG. 4, the image processing device 100B generates the second image data in which the first image and the real video are combined after receiving the real video data from the image processing device 100A, but the present embodiment is not limited to this. In some cases, the first image data stored in the image processing device 100B is not sufficient, and the image processing device 100B may not possibly combine the first image and the real video. For example, if a portion of the first image data stored in the image processing device 100B crashes when the second image of the user A is generated, the image processing device 100B may not possibly combine the first image and the real video of the user A as intended by the user A.

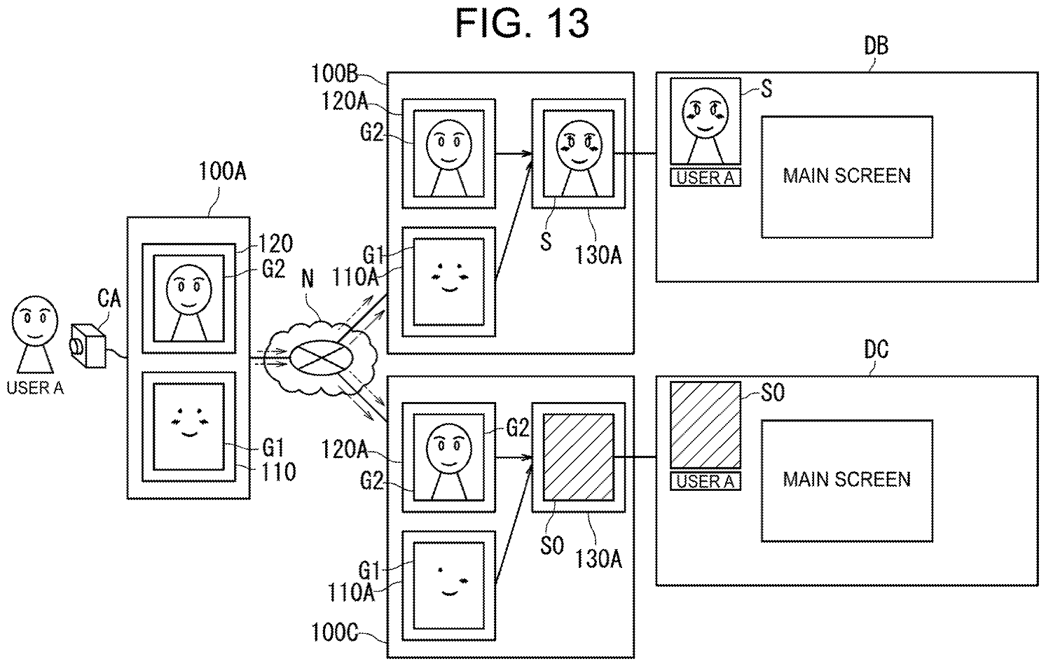

The image communication system 200 including the image processing devices 100A to 100C according to the present embodiment will be described below with reference to FIG. 13. FIG. 13 is a schematic diagram of the image communication system 200 including the image processing devices 100A to 100C according to the present embodiment.

The image communication system 200 illustrated in FIG. 13 is configured in much the same way as the image communication system 200 described above with reference to FIG. 10 except that the image processing device 100C does not partially have the first image of the user A irrespective of the instruction from the image processing device 100A, and duplicated description is omitted for simplicity. It is noted that as described above, the image processing devices 100A to 100C may be similarly configured, and here, a configuration for the generation of the second image of the user A will be focused for description, out of configurations of the image processing devices 100A to 100C.

The image processing device 100A includes the first storage 110 and the second storage 120. Further, the image/video capturing device CA is connected to the image processing device 100A. The image/video capturing device CA captures a real video of the user A to generate real video data.

The first storage 110 of the image processing device 100A stores the first image data of the user A. The second storage 120 of the image processing device 100A stores the real video data of the user A. The image processing device 100A transmits the real video data to the image processing device 100B and the image processing device 100C.

The image processing device 100B includes the first storage 110A, the second storage 120A, and the combiner 130A. The first storage 110A of the image processing device 100B stores the first image data of the user A. The first image data of the user A may be received prior to the real video data, or may be received together with the real video data. The second storage 120A of the image processing device 100B stores the real video data of the user A received from the image processing device 100A.

The combiner 130A of the image processing device 100B generates the second image data indicating the second image S of the user A obtained by combining the first image G1 of the user A and the real video G2 of the user A, based on the first image data of the user A and the real video data of the user A. For example, the combiner 130A generates the second image data so that the eyes (eyelashes), the cheeks, and the mouth of the real video G2 of the user A indicated in the real video data are replaced with the eyes (eyelashes), the cheeks, and the mouth of the first image G1 indicated in the first image data of the user A. After that, the image processing device 100B displays the second image S indicated in the second image data of the user A, onto the display device DB.

The image processing device 100C includes the first storage 110A, the second storage 120A, and the combiner 130A. The first storage 110A of the image processing device 100C stores the first image data of the user A. However, the first storage 110A of the image processing device 100C only partially stores the first image data of the user A, and does not store the first image data thereof as intended by the user A. The second storage 120A of the image processing device 100C stores the real video data of the user A received from the image processing device 100A.

Here, the first storage 110A of the image processing device 100C only partially stores the first image data of the user A. Therefore, unlike the image processing device 100B, the combiner 130A of the image processing device 100C does not generate the second image data indicating the second image of the user A. In this case, the image processing device 100C displays, instead of the real video of the user A, an alternative image S0 on the display device DC. The alternative image S0 is, for example, an image entirely in gray. Alternatively, the alternative image may be a still image such as a landscape. In the image communication system 200 according to the present embodiment, if it is not possible to perform a predetermined combination, a predetermined alternative image S0 is displayed. Thus, even if the first image is deleted due to a data crash or the like, it is possible to prevent a user from being displayed against a user's intention.

It is noted that in the above description with reference to FIG. 13, the display device DC displays the alternative image entirely in gray if the first storage 110 of the image processing device 100C does not store the first image for combination, but the present embodiment is not limited to this. The display device DC may display a blackout image. Alternatively, the display device DC may display the second image in which only a lack part is not combined. Alternatively, if the real video data includes voice data, the display device DC may output voice only.

Further, if the first storage 110 of the image processing device 100C does not store the first image for combination, the communication of the image processing devices 100A to 100C in the image communication system 200 may be ended. Alternatively, the communication of the image processing devices 100A to 100C in the image communication system 200 may be suspended until the first image data in the first storage 110 of the image processing device 100C is supplemented.

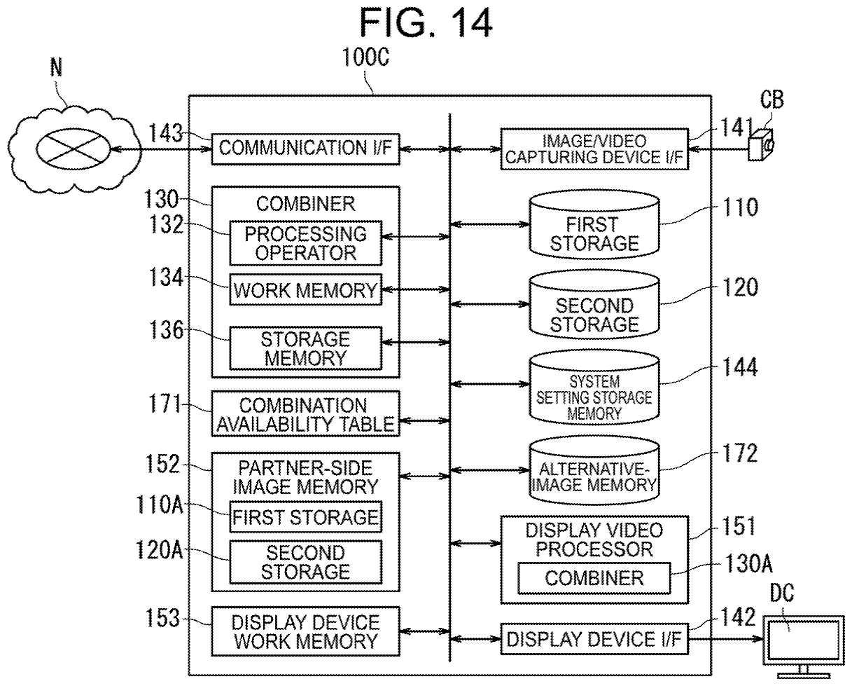

Next, the image processing device 100C according to the present embodiment will be described with reference to FIG. 14. FIG. 14 is a schematic diagram of the image processing device 100C according to the present embodiment. The image processing device 100C in FIG. 14 is configured in much the same way as the image processing device 100A described above with reference to FIG. 11 except that the image processing device 100C further includes an alternative image memory 172. Thus, duplicated description is omitted for simplicity.

The image processing device 100C further includes the alternative image memory 172 in addition to the first storage 110, the second storage 120, the combiner 130, the image/video capturing device interface 141, the display device interface 142, the communication interface 143, the system setting storage memory 144, the display video processor 151, the partner-side image memory 152, the display device work memory 153, and the combination availability table 171. As described above, the first storage 110 stores the first image data of the user A, and the second storage 120 stores the real video data of the user A.

The display video processor 151 includes the combiner 130A. The combiner 130A generates the second image data of the user A so that the first image G1 and the real video G2 of the user A are combined, based on the first image data of the user A stored in the first storage 110A and the real video data of the user A stored in the second storage 120A. The second image data is stored in the display device work memory 153. The display device DC displays the second image S of the user A, based on the second image data.

The alternative image memory 172 stores the alternative image data indicating the alternative image to be displayed on the display device DC if the combiner 130A fails to perform the combination in accordance with an instruction from the image processing device 100A. If the combiner 130A fails to perform the combination, the display device interface 142 transmits the alternative image data stored in the alternative image memory 172 to the display device DC, and the display device DC displays the alternative image, based on the alternative image data.

It is noted that a user in front of the image/video capturing device may not be necessarily in front of the image/video capturing device. In addition, an unintended user may appear in front of the image/video capturing device. For example, in the above description with reference to FIG. 1 to FIG. 14, the image/video capturing device CA captures the user A, but the user A may move from in front of the image/video capturing device CA, and a user X different from the user A may appear in front of the image/video capturing device CA.

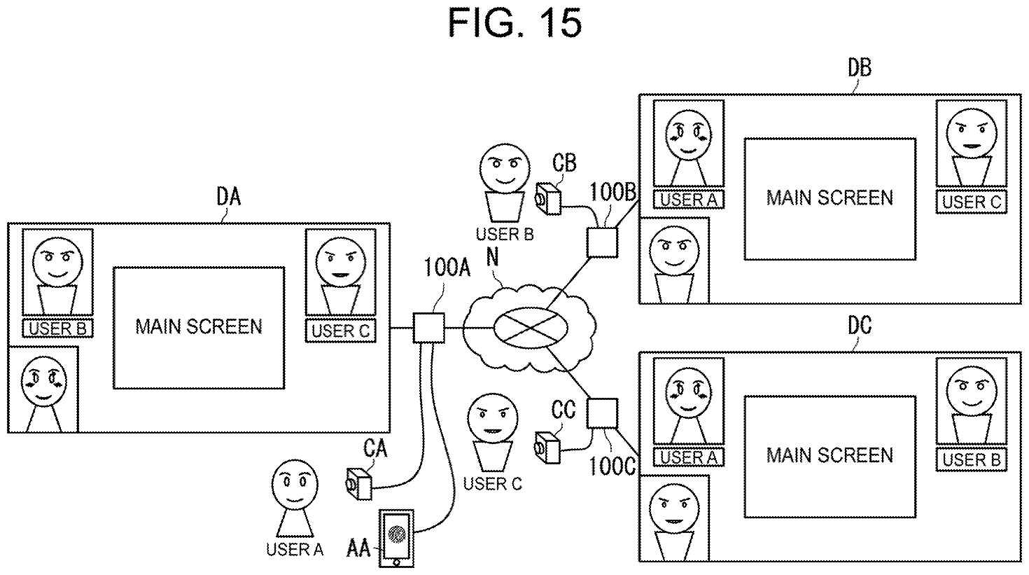

The image communication system 200 including the image processing devices 100A to 100C according to the present embodiment will be described below with reference to FIG. 15 to FIG. 17. FIG. 15 to FIG. 17 are schematic diagrams of the image communication system 200 including the image processing devices 100A to 100C. The image communication system 200 in FIG. 15 is configured in much the same way as the image communication system 200 described above with reference to FIG. 1 except that the image processing devices 100A to 100C have a function of authenticating a user, and duplicated description is omitted for simplicity. It is noted that as described above, the image processing devices 100A to 100C may be similarly configured, and here, a configuration for the user A will be focused for description, out of configurations of the image processing devices 100A to 100C.

As illustrated in FIG. 15, the image communication system 200 includes the image processing devices 100A to 100C. The image/video capturing device CA is connected to the image processing device 100A. The user A is in front of the image/video capturing device CA, and the image/video capturing device CA captures the user A to generate the real video data. The image processing device 100A is connected to an authentication device AA. It is noted that the image processing device 100A may authenticate the user A, based on the real video data of the user A.

The user A may be authenticated based on any of an identification card, a password, and a biometric authentication of the user A. For example, the biometric authentication may be any of a fingerprint authentication, a palm print authentication, a voiceprint authentication, and a retina authentication. Alternatively, the user A may be authenticated based on a body shape of the user A. Further, the image processing device 100A may authenticate the user A, based on the face. Further, the image processing device 100A may store the real video data of the user A generated by the image/video capturing device CA when the user A logs in. The image processing device 100A transmits the real video data generated by the image/video capturing device CA to the image processing device 100B and the image processing device 100C.

Similarly, an image/video capturing device CB is connected to the image processing device 100B. The user B is in front of the image/video capturing device CB, and the image/video capturing device CB captures the user B to generate the real video data. The image processing device 100B authenticates the user B, based on the real video data of the user B. The image processing device 100B transmits the real video data generated by the image/video capturing device CB to the image processing device 100A and the image processing device 100C.

Further, similarly, an image/video capturing device CC is connected to the image processing device 100C. The user C is in front of the image/video capturing device CC, and the image/video capturing device CC captures the user C to generate the real video data. The image processing device 100C authenticates the user C, based on the real video data of the user C. The image processing device 100C transmits the real video data generated by the image/video capturing device CC to the image processing device 100A and the image processing device 100B.

The display device DA displays a main screen at the center of the display screen and displays the user A at a lower left of the display screen. Further, the display device DA displays the user B at an upper left of the display screen, and displays the user C at an upper right of the display screen.

Similarly, the display device DB displays a main screen at the center of the display screen and displays the user B at a lower left of the display screen. Further, the display device DB displays the user A at an upper left of the display screen, and displays the user C at an upper right of the display screen.

Further, similarly, the display device DC displays a main screen at the center of the display screen and displays the user C at a lower left of the display screen. Further, the display device DC displays the user A at an upper left of the display screen, and displays the user B at an upper right of the display screen. It is noted that the example illustrated in FIG. 15 is merely an example of the display positions of the users A to C on the display devices DA to DC in FIG. 15, and is not limiting.

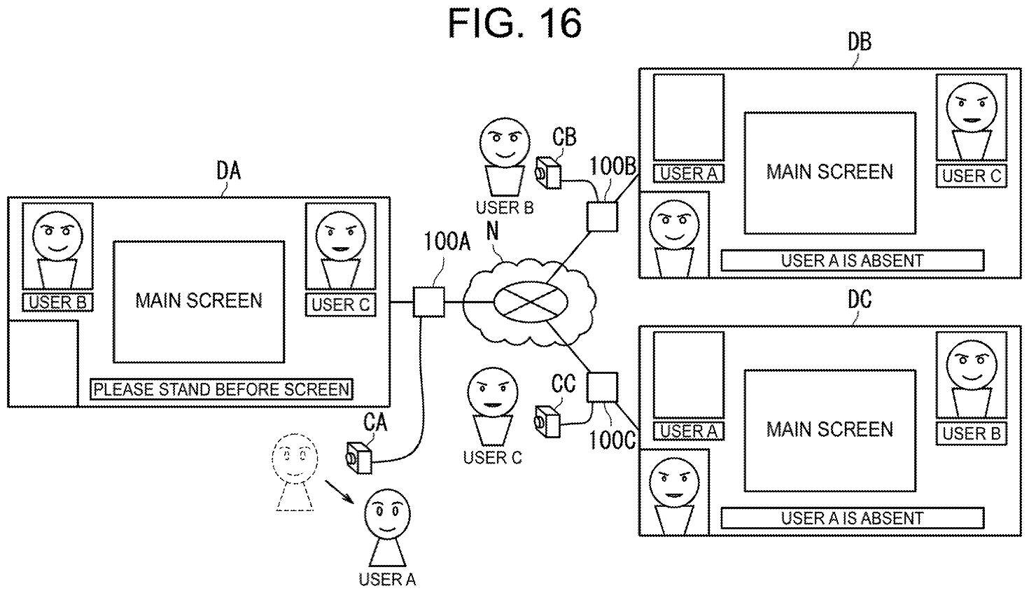

As illustrated in FIG. 16, if the user A moves from in front of the image/video capturing device CA, the image/video capturing device CA fails to capture the user A. In this case, the display device DA fails to display the user A. The display device DA continues to display the user B at an upper left of the display screen and display the user C at an upper right of the display screen, but fails to display the user A at a lower left of the display screen. The display device DA displays a white image indicating an error image at a lower left of the display screen. In addition, the display device DA displays a message urging the user A to return to the front of the image/video capturing device CA.

Similarly, the display device DB continues to display the user B at the lower left of the display screen and display the user C at the upper right of the display screen, but fails to display the user A at the upper left of the display screen. At this time, the display device DB displays a white image at the upper left of the display screen. Further, the display device DB displays a message indicating that the user A is absent.

Similarly, the display device DC continues to display the user C at the lower left of the display screen and to display the user B at the upper right of the display screen, but fails to display the user A at the upper left of the display screen. At this time, the display device DC displays a white image at the upper left of the display screen. Further, the display device DC displays a message indicating that the user A is absent.

It is noted that if the user A reappears in front of the image/video capturing device CA, the image/video capturing device CA captures the user A again. In this case, it is preferable that the image processing device 100A automatically performs a log-in operation and all of the display devices DA to DC display the user A again. Alternatively, if the user A reappears in front of the image/video capturing device CA, the display device DA may display a message indicating that the authentication device AA authenticates the user A, and based on the authentication, optionally select whether to permit the combination.

Further, the image processing device 100A may authenticate not only the user A but also authenticate the user B or the user C. If the image processing device 100A authenticates a plurality of users, the authentication may be permitted only if the image/video capturing devices CA to CC captures the users A to C, respectively. Alternatively, the authentication may be permitted only if a specific user is captured.

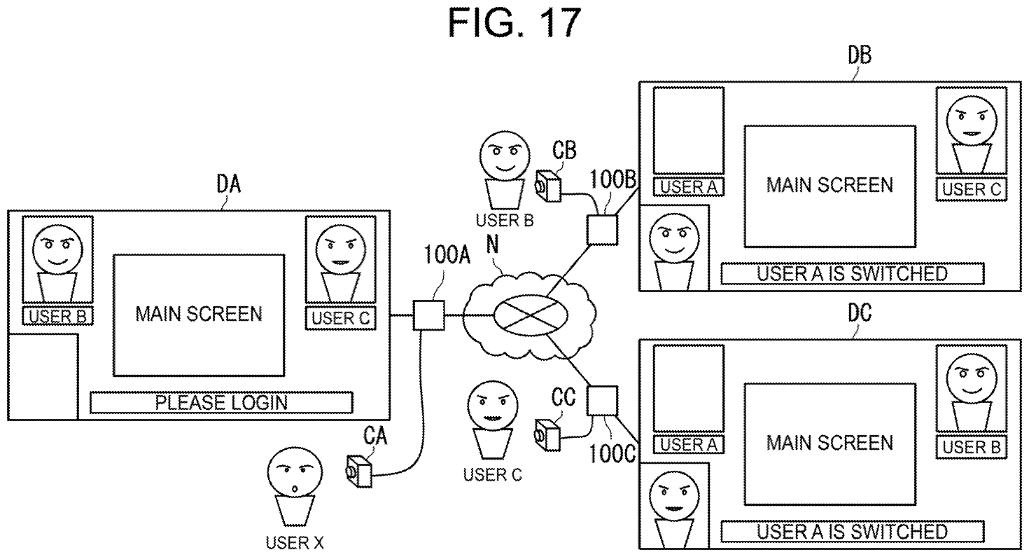

As illustrated in FIG. 17, after the user A is not present in front of the image/video capturing device CA, the user X appears in front of the image/video capturing device CA. In this case, the image/video capturing device CA captures the user X.

The image/video capturing device CA captures the user X to generate the real video data of the user X. At this time, the user X is different from the user A, and thus, the image processing device 100A does not authenticate the user X. In this case, the display device DA does not display the user A, and the display device DA still displays the white image at the lower left of the display screen. In addition, the display device DA displays a message urging the user A to log in.

Further, the display device DB still fails to display the user A, and the display device DB still displays the white image at the upper left of the display screen. Further, the display device DB displays a message indicating that the user A is switched. Similarly, the display device DC still fails to display the user A, and the display device DC still displays the white image at the upper left of the display screen. Further, the display device DC displays a message indicating that the user A is switched.

In the above description with reference to FIG. 15 to FIG. 17, if the user in front of the image/video capturing device CA is switched from the user A to the user X, the display device DA displays the message urging the user A to log in, but the present embodiment is not limited to this. If the user in front of the image/video capturing device CA is switched from the user A to the user X, the image processing device 100A may cut off the communication with the image processing device 100B and the image processing device 100C.

In the image communication system 200 according to the present embodiment, if the user is not in the front of the image/video capturing device or if another user appears in front of the image/video capturing device, the combination between the first image and the real video may not be permitted. Thus, if the same user participates as when the image processing devices 100A to 100C start communicating with one another, it is possible to display the partially changed real video of the user, and if the same user does not participate, it is possible to ensure that the real video of the user is not changed.

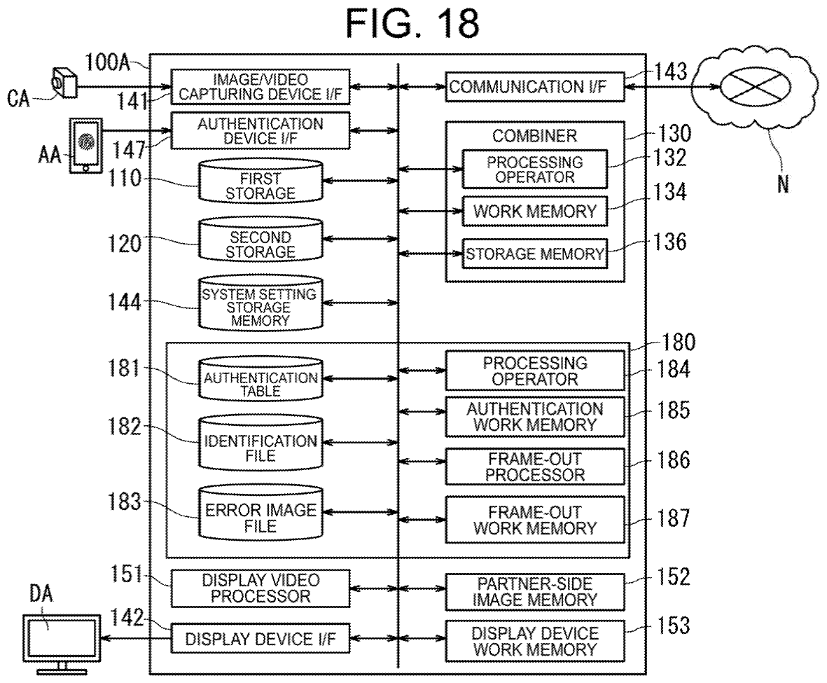

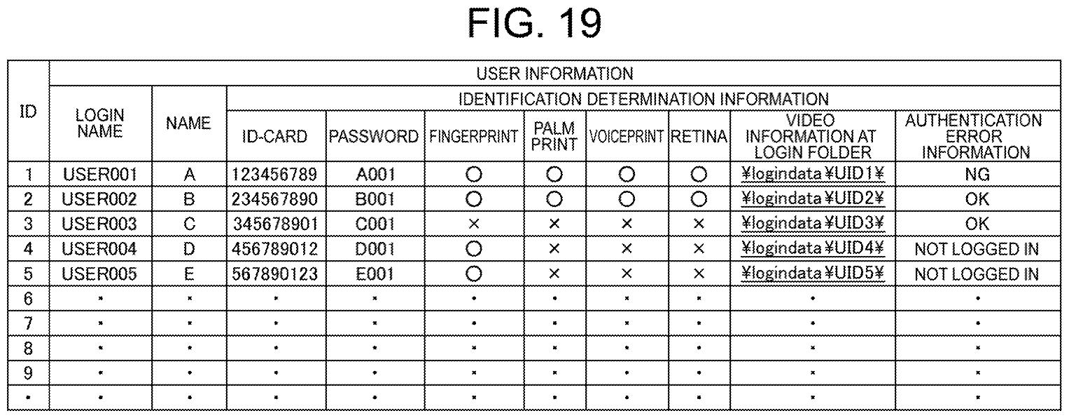

Next, the image processing device 100A according to the present embodiment will be described with reference to FIG. 18 and FIG. 19. FIG. 18 is a schematic diagram of the image processing device 100A according to the present embodiment. The image processing device 100A in FIG. 18 is configured in much the same way as the image processing device 100A described above with reference to FIG. 3 except that the image processing device 100A further includes an authenticator 180. Thus, duplicated description is omitted for simplicity.

The image processing device 100A further includes an authentication device interface 147 and the authenticator 180 in addition to the first storage 110, the second storage 120, the combiner 130, the image/video capturing device interface 141, the display device interface 142, the communication interface 143, the system setting storage memory 144, the display video processor 151, the partner-side image memory 152, and the display device work memory 153. The authenticator 180 includes an authentication table 181, an identification file 182, an error image file 183, a processing operator 184, an authentication work memory 185, a frame-out processor 186, and a frame-out work memory 187.

The authentication device interface 147 connects to the authentication device AA to receive authentication data from the authentication device AA. The authenticator 180 authenticates a user, based on an authentication result indicated in the authentication data.

The authentication table 181 stores information used for user authentication or presence/absence of the information used for user authentication. The authentication table 181 may be stored in the system setting storage memory 144 so that the authentication table 181 is used for not only the user A authentication but also for another user authentication. Here, the authentication table 181 will be described with reference to FIG. 19. FIG. 19 is the authentication table 181 in the image processing device 100A of the present embodiment.

As shown in FIG. 19, the authentication table 181 indicates, for each user ID, a login name, a name, an identification card number, and a password. Further, the authentication table 181 indicates, for each user ID, the presence or absence of information indicating a fingerprint, a palm print, a voiceprint, and a retina. The authentication table 181 also indicates an address of a folder for storing real video data at login and authentication error information.

The identification card number and the password indicated in the authentication table 181 are used for user authentication. The information indicating the presence/absence of the fingerprint, the palm print, the voiceprint, and the retina indicated in the authentication table 181 is used for user authentication. For example, all the information indicating the identification card number, the password, the fingerprint, the palm print, the voiceprint, and the retina are stored for the user A, and thus, the user A may be authenticated by using any one of the identification card number, the password, the fingerprint, the palm print, the voiceprint, and the retina.

Information indicating the identification card number, the password, and the fingerprint are stored for a user D, and thus, the user D may be authenticated by using any one of the identification card number, the password, and the fingerprint. On the other hand, the palm print, the voiceprint, and the retina of the user D are not stored, and thus, the user D may not be authenticated by using the palm print, the voiceprint, and the retina.

Now, reference is made to FIG. 18 again. The identification file 182 stores the fingerprint, the palm print, the voiceprint, and the retina of the user. The identification file 182 stores the real video data when the user logs in.

The error image file 183 stores error image data indicating an error image. If there is no user A in front of the image/video capturing device CA, the display device DA displays the error image, based on the error image data. For example, the error image is an entirely white image. Alternatively, the error image may be a specific still image.

The processing operator 184 authenticates a user. The processing operator 184 authenticates a user, based on the real video data stored in the second storage 120, the authentication table 181, and/or the identification file 182.

The authentication work memory 185 is used when the processing operator 184 authenticates a user. The authentication work memory 185 stores the real video data during the authentication. The authentication work memory 185 may store information indicating a fingerprint, a palm print, a voiceprint, and a retina read from the identification file 182 during the authentication.

The frame-out processor 186 determines whether or not the user A is not present in front of the image/video capturing device CA. The frame-out processor 186 determines whether or not the real video includes the image of the user A, based on the real video data generated by the image/video capturing device CA.

The frame-out work memory 187 is used to determine whether or not the user A is not present in front of the image/video capturing device CA. The frame-out work memory 187 stores the real video data of the user A at login.

Further, the frame-out processor 186 starts the process if the user A is not present in front of the image/video capturing device CA. For example, if the frame-out processor 186 detects that the user A is not present in front of the image/video capturing device CA, the display device DA controls the display device DA to display a message urging the user A to return to the front of the image/video capturing device CA.

Further, if detecting that a user different from the user A is present in front of the image/video capturing device CA, the frame-out processor 186 controls the display device DA to display a message urging the user A to log in. It is noted that if detecting that a user different from the user A is present in front of the image/video capturing device CA, the frame-out processor 186 may control to cut off the communication between the image processing device 100A; and the image processing device 100B and the image processing device 100C.

Typically, the authentication table 181, the identification file 182, and the error image file 183 include a non-volatile memory. According to the image processing device 100A illustrated in FIG. 18, when the user A is authenticated in front of the image/video capturing device CA, it is possible to grasp that the user in front of the image/video capturing device CA is switched from the user A. Therefore, it is possible to prevent another user from impersonating the user A to use the image communication system 200.

In the image communication system 200, the image processing device 100 permissible for each user may be determined. In this case, the authentication table 181 may include information indicating a device permissible for each user.

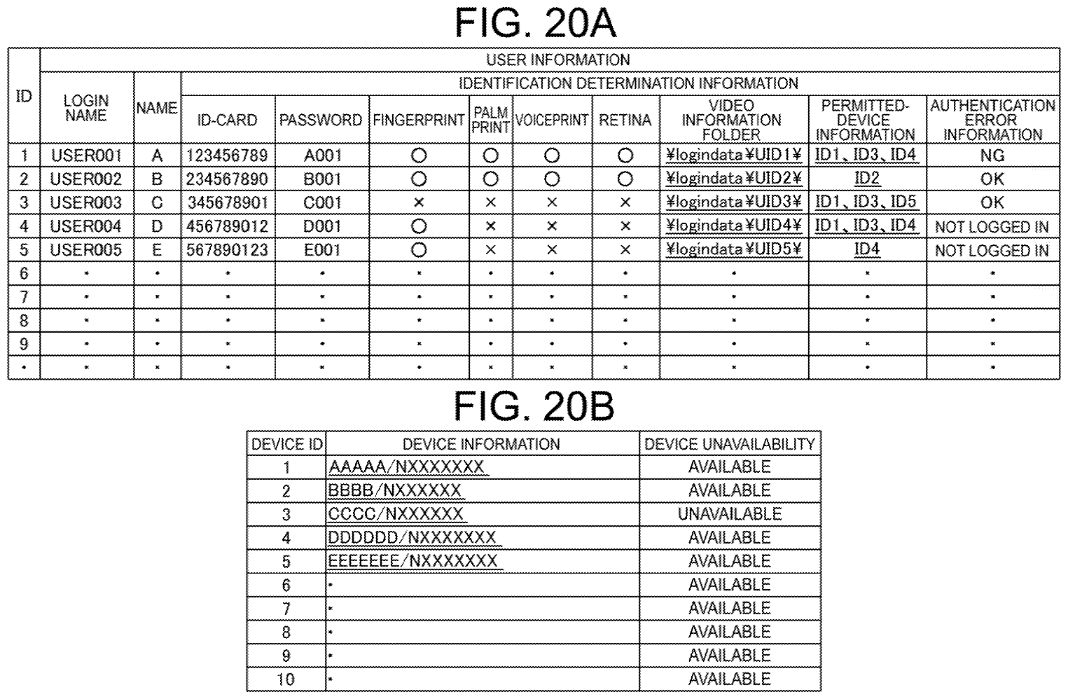

Here, the authentication table 181 will be described with reference to FIG. 20A. FIG. 20A shows the authentication table 181 in the image processing device 100A according to the present embodiment. The authentication table 181 in FIG. 20A is configured in much the same as the authentication table 181 described above with reference to FIG. 19 except that the authentication table 181 further includes permitted-device information indicating the device permissible for each user. Thus, duplicated description is omitted for simplicity. The permitted-device information is an example of permission information.

As shown in FIG. 20A, the authentication table 181 indicates a login name, a name, an identification card number, and a password for each user ID. In addition, the authentication table 181 indicates presence/absence of information indicating a fingerprint, a palm print, a voiceprint, and a retina for each user ID. The authentication table 181 indicates an address of a folder for storing the real video data of a user at login and the authentication error information. Further, the authentication table 181 indicates the permitted-device information for each user ID. The permitted-device information is indicated by using a device ID.

Here, the permitted-device information in the authentication table 181 indicates that the user A may use the image processing devices indicated by ID1, ID3, and ID4. The permitted-device information in the authentication table 181 indicates that the user D may use the image processing devices indicated by ID1, ID3, and ID4. Therefore, if a first user uses a permitted device, the combiner 130 generates the second image data, based on the permission information for permitting to generate the second image data of a second user.

FIG. 20B is a device information table in the image communication system 200 according to the present embodiment. The device information table indicates device information and availability information for each device ID. Here, the device information indicates a manufacturer, a model number, and a product number of the device, and the availability information indicates whether or not the device is available for the image communication system 200. A user or an administrator of the image communication system 200 may switch a status of the availability information. As a result, it is possible to switch whether or not the image processing device effectively functions in the image communication system 200.

It is noted that the combination by the combiner 130 may be permitted only if the real video is captured at the same position and on the same background as the first image.

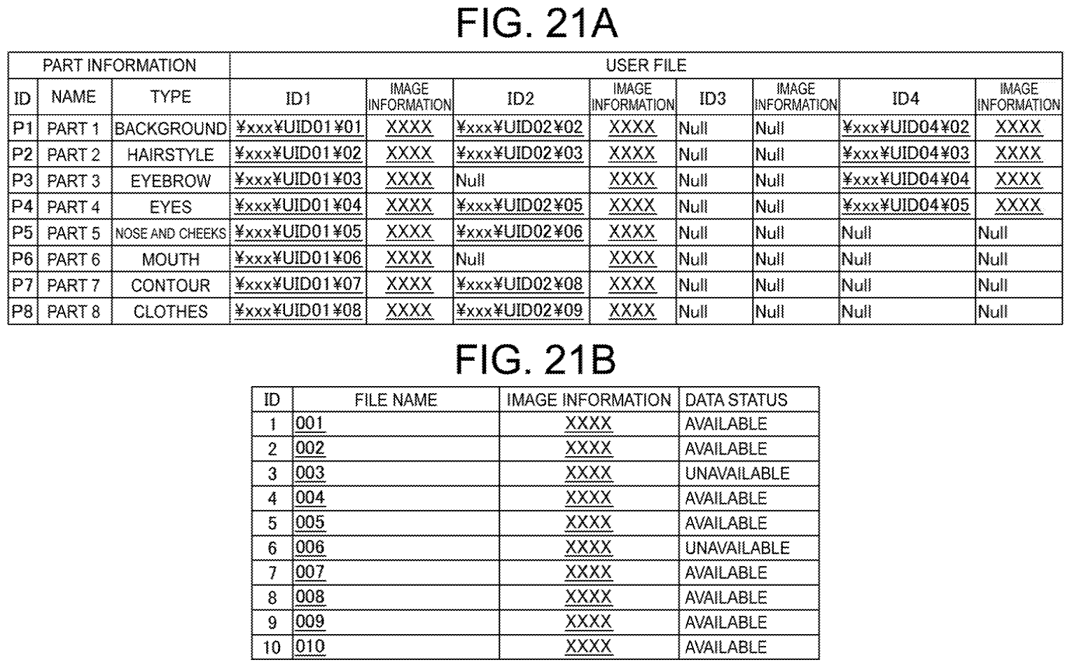

Here, the combined-part table and a permitted-image table will be described with reference to FIG. 21A and FIG. 21B. FIG. 21A shows the combined-part table in the image processing device according to the present embodiment. The combined-part table is stored in the storage memory 136 of the combiner 130 in the image processing device 100.

As shown in FIG. 21A, a name and a type of a part are indicated for each part ID in the combined-part table. In addition, the combined-part table indicates, for each part ID, an address of a folder for storing the first image data for each user ID, and image information. The image information indicates a coordinate position of the first image with respect to an entire image from which the first image is derived.

For example, if the real video is captured in a fixed state in the same room by the same image/video capturing device CA as those of the first image, a position and a size of a background in the real video are the same as a position and a size of a background in the entire image from which the first image is derived. Thus, the combiner 130 may determine whether or not the real video is captured at the same position and against the same background as those of the first image, and the combination by the combiner 130 may be permitted based on the determination result. In this case, the combiner 130 generates the second image data if a part of the first image of the user matches a part of the real video.

FIG. 21B is the permitted-image table in the image processing device according to the present embodiment. As shown in FIG. 21B, the permitted-image table indicates a file name, image information, and a data status for each ID.

Thus, the embodiment of the present invention is described above with reference to the drawings. It should be noted that the present invention is not limited to the above embodiment, and may be executed in various modes without departing from the spirit and scope of the present invention. In addition, various inventive modes may be achieved by appropriately combining a plurality of constituent elements disclosed in the above embodiment. For example, some of all the constituent elements described in the embodiment may be omitted. Further, constituent elements across different embodiments may be appropriately combined. In the drawings, mainly, constituent elements are schematically illustrated for easy understanding, and various changes may be made without substantially departing from the effects of the present invention.

According to the present invention, it is possible to display a partially changed real video of a user.

### DESCRIPTION OF REFERENCE NUMERALS

100 Image processing device
110 First storage
120 Second storage
130 Combiner

What is claimed is:

1. An image processing device comprising:
a first storage that stores first image data indicating a first image of a user;
a second storage that stores real video data indicating a real video of the user; and
a combiner that generates second image data indicating a second image of the user, where the second image is obtained by combining the first image and the real video, based on the first image data and the real video data.

2. The image processing device according to claim 1, wherein the combiner replaces a part of the real video with the first image to generate the second image data so that the first image moves in synchronization with the real video.

3. The image processing device according to claim 1, further including a communicator that transmits the second image data.

4. The image processing device according to claim 3, wherein the combiner combines voice data indicating a real voice of the user with the second image data with a delay time required by the combiner to combine the first image and the real video.

5. The image processing device according to claim 1, further including a communicator that receives the real video data.

6. The image processing device according to claim 5, wherein an alternative image is used if the first storage does not store the first image data indicating the first image to be combined with the real video.

7. The image processing device according to claim 1, further including a communicator that receives the real video data and transmits the second image data.

8. The image processing device according to claim 1, further including an authenticator that authenticates the user.

9. The image processing device according to claim 1, wherein the combiner generates the second image data, based on permission information for permitting generation of the second image data of the user.

10. The image processing device according to claim 1, wherein the combiner generates the second image data if a part of the first image of the user matches a part of the real video of the user.

11. An image communication system comprising:
a first image processing device; and
a second image processing device connected to the first image processing device via a network,
wherein at least one of the first image processing device and the second image processing device includes:
a first storage that stores first image data indicating a first image of a user;
a second storage that stores real video data indicating a real video of the user; and
a combiner that generates second image data indicating a second image of the user, where the second image is obtained by combining the first image and the real video, based on the first image data and the real video data.

12. The image communication system according to claim 11,
wherein the second image processing device includes the first storage, the second storage, and the combiner, and
wherein the first image processing device transmits the real video data to the second image processing device.

13. The image communication system according to claim 12,
wherein the first image processing device includes a communicator that transmits the real video data, and
wherein the communicator transmits, to the second image processing device, a combination selection signal for designating combination by the combiner of the second image processing device.

14. An image processing method comprising:
storing first image data indicating a first image of a user;
storing real video data indicating a real video of the user, and
generating, based on the first image data and the real video data, second image data indicating a second image of the user, where the second image is obtained by combining the first image and the real video.
